(19) United States
(12) Patent Application Publication
(10) Pub. No.: US 2008/0040446 A1
(43) Pub. Date: Feb. 14, 2008

(54) METHOD FOR TRANSFER OF DATA

(75) Inventor: ROLF MEYER, Wennigsen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Sennheiser electronic GmbH & Co. KG

(21) Appl. No.: 11/697,419

(22) Filed: Apr. 6, 2007

(30) Foreign Application Priority Data
Apr. 7, 2006 (DE) 10 2006 016 828.3

(51) Int. Cl. G06F 15/16

(52) U.S. Cl. 709/217

(57) ABSTRACT

The invention provides a method for transferring data, in particular data pertaining to copyright, from a server with a first Internet Protocol address to a mobile device with a second Internet Protocol address. A mobile device transmits a request for at least one file by a mobile device. The first server receives the request of the mobile device and identifies the mobile device based on the Internet Protocol address. The authorization of the mobile device is checked based on the Internet Protocol address of the mobile device. The files requested by the mobile device are transferred when the mobile device has an appropriate authorization.

### CROSS-REFERENCE TO RELATED APPLICATION

This application claims priority of German Application No. 10 2006 016 828.3, filed Apr. 7, 2006, the complete disclosure of which is hereby incorporated by reference.

### BACKGROUND OF THE INVENTION

a) Field of the Invention

The present invention is directed to a method for transferring data.

b) Description of the Related Art

The prevalence of digitally compressed music, e.g., in the form of MP3 files, has risen sharply in recent years. Audio files are digitized and stored, for example, on a hard disk of a computer or the like. Thus, in the private sector, more and more computers are used as music servers, and the computer is used to play back the audio files stored in it. Accordingly, it is possible to listen to music using cables and, when the computer has a radio interface, for example, it is also possible to listen to music wirelessly and to transmit the audio files or audio signals wirelessly. Further, music servers offering audio files at no charge or for a fee are connected to the Internet. A user can download the purchasable or free audio files onto his or her own computer from the Internet and then listen to the downloaded audio files. By means of a mobile phone or a SmartPhone-equipped PDA, a user can access the Internet using HSCSD, GPRS, UMTS or the like and can accordingly also download audio files of the type mentioned above. However, it is disadvantageous that a large amount of data must be transferred when the data transfer rate is slow, as is often the case.

A PDA or a notebook with a WLAN interface (IEEE 802.11) can also access the Internet wirelessly provided the PDA or notebook is located within a transmission range of a WLAN access point. This is particularly advantageous with respect to the data transfer rate compared to a mobile radio connection.

DE 20 2004 005 111 U1 shows wireless Bluetooth headphones which have an electroacoustic transducer and a transmission/reception unit for wireless reception of signals containing reproducible audio signals.

DE 101 14 670 A1 shows a mobile multimedia device with a first transmission/reception unit for communicating with a mobile radio network and a second transmission/reception unit receiving radio frequencies. A reception authorization that has been received via the first transmission/reception device is stored in a transmitter. Further, the multimedia device has decoding means for decoding the multimedia content that is received in encrypted form via the second transmission/reception unit. An authorization request for multimedia content is transmitted wirelessly by the first transmitting device.

However, the above-described downloading of data, particularly audio files, from the Internet is not always legitimate with respect to copyright.

### OBJECT AND SUMMARY OF THE INVENTION

Accordingly, it is the primary object of the present invention to provide mobile access to data stored on an Internet server which appear to be legitimate with respect to copyright.

In accordance with the invention, a method for transferring data, in particular data pertaining to copyright, from a server with a first Internet Protocol address to a mobile device with a second Internet Protocol address, comprising the following steps: transmitting a request for at least one file by a mobile device, receiving the request of the mobile device through a first server, identifying the mobile device based on its Internet Protocol address, checking the authorization of the mobile device and transferring the requested file from the server to the mobile device when the mobile device has an appropriate authorization.

Accordingly, a method is provided for transferring data, particularly data pertaining to copyright, from a server with a first Internet Protocol address to a mobile device with a second Internet Protocol address. A mobile device transmits a request for at least one file. The first server receives the request of the mobile device and identifies the mobile device based on the Internet Protocol address. The authorization of the mobile device is checked based on the Internet Protocol address of the mobile device. The files requested by the mobile device are transferred when the mobile device has a corresponding authorization.

The invention is directed to the idea of providing a mobile device to which audio files, for example, can be transmitted wirelessly provided it is located within a transmission range of, for example, a WLAN access point. Alternatively, the transmission can also be carried out using wires. In this case, a connection is established between the headphones or the reception device and a server and/or server service that supports client functionalities. The server and/or server service can be an internal server and/or server service or an external server and/or server service whose connection data are known and to which the user has access rights. More exactly, a connection is made by wire or partially or entirely wirelessly between the access point and the server or server service on which the data to be downloaded is located. The data are then transmitted wirelessly from the access point to the mobile device, for example, based on a WLAN interface (e.g., IEEE 802.11). Accordingly, it is possible for the user's own digitally stored music to be received wirelessly within the transmission range of a WLAN access point. Because the user's own music is being accessed, a continuous confirmation of authorization is possible so that this access appears legitimate with respect to copyright. Access of the mobile device to its own data is carried out in the same way regardless of whether the mobile device is located within a transmission range of its own private WLAN access point or within the transmission range of a public WLAN access point.

For authorized access to the user's own audio data, it is not absolutely necessary to physically possess a storage medium containing this audio data. Audio data which can be accessed in an authorized manner within the meaning of the present invention can be the user's own music storage medium, audio data which can be downloaded from a web-based service, possibly for a fee, or audio data which can be copied, possibly for a fee, to a server and/or server service to be determined and from which the audio data can then be retrieved at will. In particular, non-physical purchasing of audio data should be mentioned in connection with the present invention.

The required storage space in the private environment may be insufficient for storing all of the audio data. It is also conceivable for a web-based service or provider to assume storage and be accessed in the customary manner. This service could also be a pay service or included in other service contracts.

The invention is further directed to the idea of designing the mobile device not only as a passive audio receiver but also as an active network element or as a web client which makes an Internet service available so that other network elements can also have access to it.

Accordingly, the mobile device is not only a merely passive receiver of audio signals but is now also an active network element. This ensures that the mobile device is uniquely identifiable in a network. The mobile device can be accessed via the Internet based on the IP address, i.e., the mobile device is addressable on a worldwide basis.

According to another aspect of the present invention, the IP address of a network element in a wireless network in which the mobile device is located is assigned.

According to another aspect of the present invention, the mobile device has a buffer for temporary storage of the received signals. By means of a buffer of this kind, temporary interruptions in the reception of the first signals can be bridged without needing to stop the playback of the audio signals by an electroacoustic transducer. The buffer storage can be a component part of the transmission protocol (streaming protocol) or can be implemented in the application software as a supplement to the transmission protocol.

According to another aspect of the present invention, the mobile device has a display unit for displaying second signals which were received by the transmission/reception unit together with the first signals. In this way, additional information about the audio signals, e.g., a title and a performer of a piece of music, can be displayed on the display unit.

According to another aspect of the present invention, the mobile device has selector buttons. By means of the selector buttons, the user can influence the display on the display unit and can communicate with other network elements in the network. In this way, the user can, for example, select audio files stored on a server in the network so that these audio files can be transmitted to the mobile device for playback.

The invention will be described more fully in the following with reference to the drawings.

### BRIEF DESCRIPTION OF THE DRAWINGS

In the drawings:

FIG. 1 shows a basic layout of a transfer system according to the invention;

FIG. 2 shows a playback device according to a first embodiment example;

FIG. 3 shows a playback device according to a second embodiment example;

FIG. 4 is a block diagram of a multimedia network;

FIG. 5 shows a multimedia network according to a third embodiment example of the invention; and

FIG. 6 shows a block diagram of wireless headphones according to the third embodiment example from FIG. 5.

### DESCRIPTION OF THE PREFERRED EMBODIMENTS

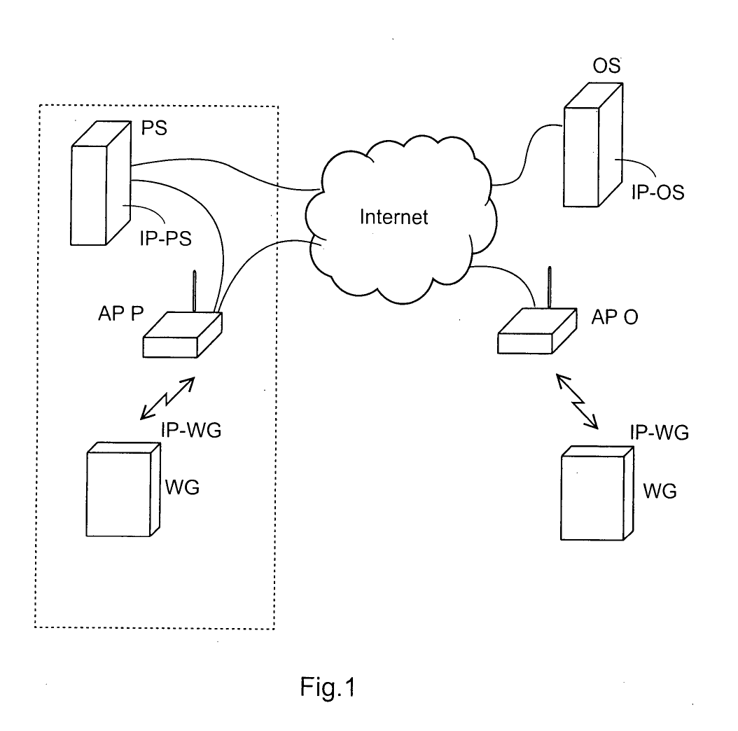

FIG. 1 shows a basic layout of a transfer system according to the invention. The drawing basically shows a private zone and a public zone which are connected to one another via the Internet. A private sector PS which is, e.g., wired to an access point APP is shown in the private zone. This access point APP is based, for example, on a WLAN interface and communicates wirelessly with a playback device WG located in the transmission range of the access point APP. A public server OS which is, e.g., wired to the Internet is arranged in the public zone. Further, another access point APO is shown which is likewise wired to the Internet. This access point APO is based, for example, on a WLAN interface and communicates wirelessly with a (mobile) playback device WG located within its transmission range.

For communicating with the private access point APP or with the public access point APO, a playback device WG has a WLAN interface. In addition, the playback device is assigned its own IP address. Communication of a playback device WG in a transmission range of the private access point AP is carried out wirelessly until the private access point APP and is then preferably wired between the private access point APP and the private server. Alternatively or in addition, the private access point APP can be, e.g., wired to the Internet. Accordingly, communication would be possible between the playback device WG in the transmission range of the private access point APP and a public server OS in that the private access point APP is connected to the public server OS via Internet.

Alternatively, the playback devices WG can also communicate with the access point by wire.

Communication between the playback device WG in the transmission range of the public access point APO and a public or private server OS, PS is carried out wirelessly until the public access point APO and then, via the Internet, to the public server OS or private server PS.

Therefore, the playback device WG can access the private server PS as well as the public server OS as long as it is located with a transmission range of an access point regardless of whether or not it is located in a private zone or public zone.

Communication between the playback device WG and the public server OS or the private server PS is carried out in particular via the Internet Protocol. For this purpose, the playback device has a corresponding IP address IP-WG and the private and public servers likewise have corresponding IP addresses IP-PS, IP-OS. The mutual communication is accordingly carried out based on the respective IP addresses. This has the particular advantage that the public server OS or the private server PS can determine whether or not the receiver of the data is also actually the playback device WG. If the IP address of the data receiver does not match the IP address IP-WG of the playback device WG, a transfer of the respective data can be forbidden. The party to whom the respective data was transferred can also be tracked based on the IP address.

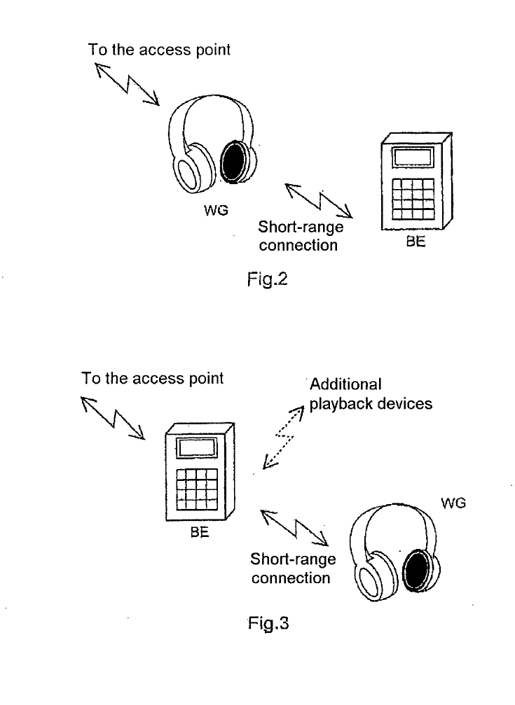

FIG. 2 shows a schematic view of a playback device from FIG. 1 according to a first embodiment example. According to the first embodiment example, the playback device is constructed as headphones with a WLAN interface. In other words, the headphones communicate directly with an access point based on a WLAN interface. Accordingly, no additional equipment is required for receiving the wirelessly transmitted signal. All of the necessary elements are integrated in the wireless headphone. Therefore, data can be received wirelessly by means of the wireless WLAN headphones insofar as the headphones are located within a transmission range of a WLAN access point.

As an alternative to a WLAN interface, the playback device can also have an interface which enables wired communication with the access point. As an alternative to the WLAN interface, the playback device can also have a wireless interface based on another wireless communications protocol.

To facilitate use of the wireless headphones, an external operating element BE can be provided. Communication between the operating element BE and the headphones can be carried out by wire or wirelessly (IR, Bluetooth, HF). The operating element is used only to operate the wireless headphones. A WLAN interface is not integrated in the operating element BE. Alternatively, the operating element can also be integrated in the headphones.

FIG. 3 shows a schematic view of a playback device according to a second embodiment example. Headphones and an operating element BE are shown again. In contrast to the first embodiment example, however, a WLAN interface is integrated in the operating unit BE so that the operating unit communicates wirelessly with an access point. The received data are transmitted to the headphones by wire or wirelessly (IR, Bluetooth, HF, etc.) by the operating unit BE. According to the second embodiment example, the WLAN interface is accordingly integrated in the operating unit BE, while the headphones are only conventional headphones.

The integration of the WLAN interface in the operating unit BE proves advantageous with respect to the required battery voltage because an operating element of this type offers more space.

An operating element according to the second embodiment example of the invention can be any device with a WLAN interface such as, e.g., a notebook, a PA, a cell phone, a Voice over IP telephone, or the like. Further, the operating element can be implemented as an MP3 player with a WLAN interface. When an operating element of this kind has a sufficiently large temporary storage or buffer, a plurality of audio files can be loaded on the operating element beforehand so that they can be played back later whether or not there is a connection to an access point.

The operating element according to the second embodiment example can accordingly also deliver a corresponding audio signal to additional headphones either by wire or wirelessly.

By means of the above-described wireless headphones with integrated WLAN interface, a wearer of headphones of this type can listen to music whenever the wearer is within transmission range of a WLAN access point. High-quality audio playback is possible because of the high transfer rate in WLAN. Further, the corresponding data of the audio files or music to play back can be downloaded substantially in real time so that only a very small temporary storage or buffer is needed in the headphones. Alternatively or in addition, the corresponding data can also be loaded at higher speed and stored in the temporary storage or buffer in a corresponding manner. Accordingly, the headphones can also be supplied with music and can play back this music when the headphones are not within a transmission range of a WLAN access point. The wireless headphones substantially have all of the required hardware components required for downloading and playing back audio files which are downloaded from the Internet.

In order to reduce the data to be transferred, the audio files can be stored and transferred in compressed form such as, e.g., MP3, MP3pro, WMA, Ogg Vorbis, or the like. Accordingly, decompression first takes place in the receiver, i.e., in the wireless headphones. Therefore, the wireless headphones must have a unit for decompressing the compressed audio signals and corresponding software. Alternatively, the required software can be transmitted together with the audio files or before the audio files. This is particularly advantageous because there may be different versions of headphones of this type from different manufacturers and the respective headphones are always provided with the latest software versions.

According to both the first and second embodiment examples, a playback device, i.e., an operating element or wireless headphones, can receive and also transmit data. Accordingly, headphones of this kind can receive data from an access point wirelessly and then send these data to another playback device. This can be carried out either in a wired manner or wirelessly based on infrared, Bluetooth, HF, or the like. Accordingly, not only audio files but also audio streams can be received by the playback device simultaneously and forwarded in a corresponding manner. Further, the playback device, i.e., the wireless headphones or the operating element, can control playback on external playback devices with respect to time in such a way that the playback is carried out synchronously. Alternatively, the playback can be correspondingly delayed in the wireless headphones connected to the access point to achieve a synchronous playback on all of the playback devices. Accordingly, the wireless headphones or the operating element is essentially designed as a master and the other playback devices are implemented as slaves. Accordingly, wireless headphones or an operating element will be a local server and will make the stored audio files available to other playback devices. The transmission of the data stored in the wireless headphones or operating element can be carried out either in real time or at a higher speed so that the other playback devices enable playback later or with a delay depending on the size of their temporary storage or buffer.

According to a preferred embodiment example of the invention, the wireless headphones are designed in such a way that they log onto a WLAN access point when switched on provided they are located within a transmission range of a WLAN access point. The wireless headphones then connect to a determined server on which the audio signals to be transmitted are found. This can be carried out, for example, using the Internet Protocol based on a specific IP address of a server of this kind. This server can be a private server which, for example, is permanently connected to the Internet by a DSL connection. Alternatively, the data to be downloaded can also be located on another server which is permanently connected to the Internet.

The wireless headphones according to the first and second embodiment examples check at regular intervals to determine whether they are within a transmission range of an access point. As soon as they determine that they are in a transmission range of an access point and a connection has been established to this access point, the user is informed of this either optically through an LED display or acoustically by a signal tone in the headphones or mechanically by a vibration. This message can also be carried out at the operating element when one is provided. A message of this kind can also be switched off.

Further, the user can decide whether or not to make contact with a server.

A connection to a server on which the data to be transferred is found is initiated by actuating selector buttons at the wireless headphones or at the operating element. Therefore, a connection is initiated without needing to enter additional target information because this information has already been stored in the headphones previously. When the connection to the WLAN access point is interrupted during a transfer of data, the headphones attempt at predetermined intervals to re-establish a connection and to resume the transfer of the corresponding data until all data are transferred.

The data are transferred in encrypted form in order to improve a continuous verification of authorization and to prevent unwanted listening in or misuse of the transfer of data between wireless WLAN headphones and a specific server or headphones. A corresponding encryption can be varied during the transfer at intervals defined beforehand or from one download to another. Existing web functionalities, e.g., SSL, can also be used for encryption.

According to another embodiment example of the invention, an operating element described with reference to the second embodiment example of the invention is arranged in an automobile or the like. However, in this case, it should be ensured that the temporary storage or buffer has a sufficient size because it is not always guaranteed that the operating element is located within a transmission range of a WLAN access point. Therefore, data should be loaded at a fast rate preferably before driving or at fixed stations, e.g., a rest stop or filling station. Alternatively or in addition, additional access points in which specific information is stored about the surroundings, e.g., tourist attractions, traffic advisories, navigation information, or the like, can be realized, for example, on the outskirts of a city. This information to be reproduced can be audio information and video information, and playback is also possible via built-in loudspeakers or built-in video screens installed in the automobile. Playback of the information can also be initiated by a navigation system or other position information (e.g., mobile radio or GPS).

This is also possible when the user is aboard an aircraft or a train. In this case, the WLAN access point is arranged in the train or aircraft so that the user is always located within a corresponding transmission range of a WLAN access point.

Since the amount of data stored on a private server PS or a public sever OS can be very large, it must be ensured that a user can navigate within these data. For example, a program which sorts and correspondingly pre-defines the data found on the server can be implemented on the server for this purpose. As soon as the wireless headphones establish a connection to this server, the corresponding audio files are transmitted to the wireless headphones so that they can play them back. Navigation can be carried out either by selector buttons at the headphones or by a speech input by means of an additional microphone. In other words, a user can control a corresponding navigation program on the server by means of selector buttons and by spoken commands. Alternatively, the navigation program can be a component part of the headphones, and the commands are then translated in such a way that they are understood by the server and the corresponding commands are carried out. An operating element with a display can either be integrated in the headphones or provided as a peripheral device. Accordingly, by means of the selector buttons and the display in the operating element, the user can navigate through the structured files and databases on the private server or public server and select them in a corresponding manner.

When establishing a connection between the wireless headphones and the specific server on which the corresponding data are stored, information about the structure of the data and audio database can be transmitted beforehand. As soon as these data are stored in the temporary storage or buffer, an offline navigation can be carried out when the wireless headphones are not within a transmission range of a WLAN access point.

Alternatively or in addition to the above, the server on which the data are stored can be designed to generate a synthesized announcement about the data to be transferred. This synthesized announcement can be stored in the memory of the playback device. The announcement can be generated as an MP3 file, a Wafe file, or the like and can be stored correspondingly in the playback device so that this file can be reproduced during playback or at the start of playback of the data. This is advantageous particularly for playback devices without a display because the title of the audio output can be announced to the user. As was already mentioned above, the title announcement is preferably generated from the filename or ID tag in MP3 files by speech synthesis. This speech synthesis is preferably carried out in the server or can already have been carried out beforehand and the resulting synthesized announcement can likewise be stored on the server. The playback device need not be made more complex to ensure that the synthesized announcement can be played back because the speech synthesis is carried out on the server or on front-end equipment rather than in the playback device.

The title of a file, the duration of the file and secondary information such as, e.g., conductor, performer, or the like can preferably be provided as a synthesized announcement.

As an alternative to the above, the speech synthesis can be carried out when requesting the corresponding files for transfer. This proves advantageous in that it can save storage space on the server because the synthesized announcement need only be made for files which are actually to be downloaded.

The speech synthesis described above can also be used for navigating through the menu control of listings on the server. For this purpose, the menu structure is correspondingly subjected to a speech synthesis so that the menu structure of the listings can be played back acoustically in the playback device.

Alternatively or in addition to the above, the acoustic announcements with respect to the files can be generated beforehand and stored together with the data or files. Alternatively, the announcements can be generated based on results.

As was already mentioned above, the operating element can be connected to the wireless headphones either by wire or wirelessly. After selecting the audio files to be downloaded, the operating element need not be used again because all of the corresponding data are stored in the wireless headphones or have been transferred to the corresponding server.

Apart from navigating within the data or databases on the specific server, it is also desirable to navigate within the audio files. For this purpose, selector buttons can again be provided at the wireless headphones or at the operating element. These selector buttons are preferably identified by tactile features so that the headphones need not be removed when navigating within a piece of music. Selector buttons of this kind are, for example, Start, Stop, Previous/Next Track, Previous/Next Song, etc. The selector buttons can also have multiple functions to enable navigation within a piece of music as well as within the files or databases on the server.

The commands or instructions entered by the user with the operating element or selector buttons are sent to the specific server by the return path of the WLAN interface. In this connection, the commands can be conveyed as machine instructions or in the form of ASCII symbols. The commands to the server and/or server service are carried out in agreed-upon, preferably standardized form, e.g., byte sequences or also sound sequences.

Alternatively or in addition, the possible commands can also be transmitted along with a transmission of the corresponding software when establishing a connection between wireless WLAN headphones and a corresponding server with a specific IP address.

Since the IP address of the wireless headphones and of a server must be known for communication between the wireless headphones and the server, it is not important whether the wireless headphones communicate with a public or a private server. In order to achieve maximum accessibility to data, the data are stored on a server which has permanent Internet access. Therefore, a transmission or transfer of data takes place only from a virtual internal storage location to the wireless headphones. Accordingly, the copyright for the data found on the servers is not infringed insofar as the user has the appropriate authorization.

Providers can establish a service in the form of a physical “kiosk” whose range is entered, or within whose range the mobile device is located, in order to download music or information. These data can be present directly on the local server or can be loaded from remote servers, e.g., on the Internet. The data can also be the user's own data which has been deliberately transferred before starting a trip. Further, this “kiosk” can exist locally or on the Internet on a server in the form of a web service as a virtual “kiosk” in the form of suitable software. The functionalities of a kiosk can be imitated in a corresponding manner. As was already described above, navigation is carried out by an operating device, control buttons and a display on the headphones or by speech navigation.

In order to finance public access points, the operators of such access points can insert advertisements between the transmitted signals. Alternatively or in addition, operations information, e.g., in airports, such as flight schedules, various announcements, delays, or the like can be inserted.

Although the embodiment examples described above refer substantially to audio files, the invention is not limited to audio files. Videos, video clips, Internet radio, Voice over IP, or the like can likewise be implemented according to the invention.

Further, the invention described above can also be used in conferences in which a participant has corresponding wireless headphones. Based on the IP address of the wireless headphones, the corresponding audio signals can be played to the user in the correct language. For example, when a headset is used, the voice of the user can be transmitted to the conference system by means of a microphone to transmit speech. It is also possible to transmit specific messages to the appropriate persons by means of the unique IP addresses.

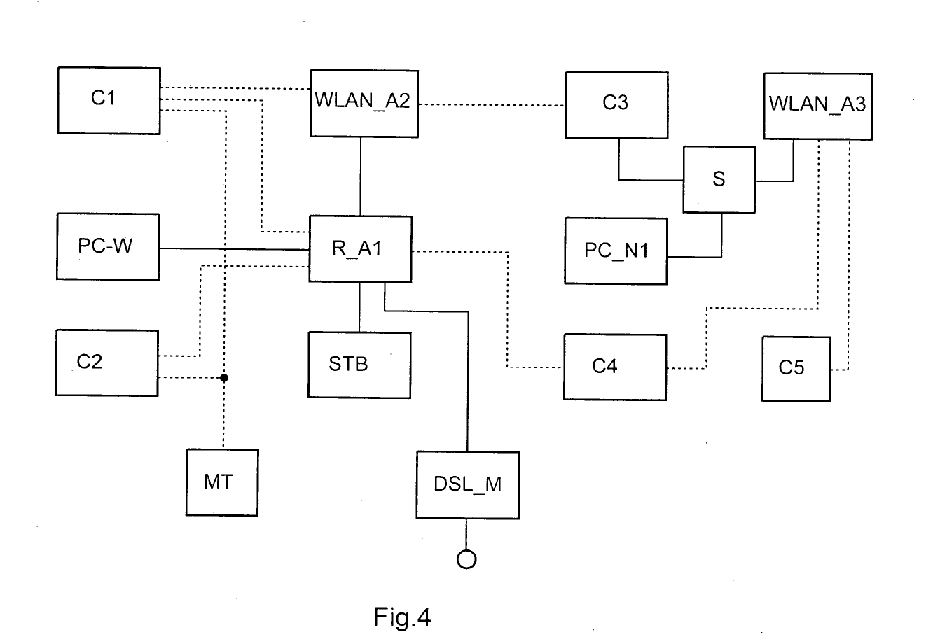

FIG. 4 is a block diagram of a multimedia network. This network is based substantially on a Local Area Network LAN and a Wireless Local Area Network WLAN. The LAN is represented by the solid lines, while the WLAN is represented by the dashed lines. The network is connected to the Internet by a DSL modem DSL_M. A router R_A1 is connected to the DSL modem and serves as a central access point for the LAN network and for the WLAN network. A first client C1 is, for example, a PDA, a pocket PC, or the like and plays audio data and video data wirelessly from the available network. For example, headphones can be connected to the first client C1 for playing back the audio signals. Further, the first client C1 can play live Internet radio or a user can operate Internet telephony (Voice over IP) in this way.

A computer PC_W can be arranged in a living room, for example, and be used to store audio data and video data. Further, this computer can serve as a data server for storing data in the network. The computer can access the Internet via the router R_A1 and the DSL modem DSL_M, and audio data and video data can be downloaded from the Internet and stored in a corresponding manner. Alternatively, not only data but also digital photos can be stored. This computer PC_W is connected, for example, to the central router R_A1 via a LAN connection.

A second client C2 is arranged, for example, in a work room and connected to the central router R_A1 by a WLAN connection. A printer or the like can be connected to this computer, for example.

A set top box STB can be connected to the router R_A1 by means of the LAN. This set top box STB is a digital receiver, for example, and receives audio signals and video signals via a satellite and makes these data or signals available to other network elements. The signals received by the set top box STB can be transferred, e.g., by means of the LAN, to the computer PC_W and stored therein.

A WLAN access point WLAN_A2 serves as a second access point in addition to the router with the first access point R_A1 and expands the reception range of the WLAN network, for example, to premises or to a neighboring house. A third client C3 is arranged, for example, in a neighboring house and is located within the reception area of the WLAN_A2, i.e., within the reception area of the second access point. The third client is connected by a switch S to a neighbor's computer PC_N1 and to a third WLAN access point WLAN_A3. This third access point serves to expand the WLAN to other premises or another house.

The computer in the neighboring house PC_N1 corresponds substantially to the computer PC_W. A fourth client C4, for example, a notebook in the neighboring house, is connected to the first access point R_A1 and to the third access point WLAN_A3 by a wireless connection and router. A fifth client C5 of another neighbor is connected to the third access point by a WLAN connection.

A Wireless Local Area Network WLAN refers to a wireless local radio network which is generally based on the IEEE 802.11 family of standards. WLAN networks usually work within an infrastructure mode in which one or more base stations, i.e., wireless access points, control communication between the clients in the network. The transfer of data is generally carried out via the different access points. Alternatively, an ad-hoc network is also possible in which the clients communicate with one another directly. An ad-hoc network of this kind is a wireless network architecture which is formed between two or more mobile end devices without a fixed infrastructure.

An Internet Protocol address is assigned to each client C1-C5 and each PC PC_W, PC_N1, for example, by the router R_A1. An IP address allows a logical addressing of computers or network elements in IP networks such as, e.g., the Internet. These IP addresses are entered in the source address field and target address field in every IP packet, i.e., every IP packet contains information about the address of the transmitter and of the receiver. Version 4 of the Internet Protocol IPv4, for example, allows the use of IP addresses with 32 bits which are separated by four dots. Every 32-bit IP address is divided into a network part and a device part (host part). In the simplest case, the first 16 bits identify the network part and the last 16 bits identify the device part. The sixth version of the Internet Protocol is based on the use of 128-bit addresses. The IP addresses can either be permanently assigned to a network element or can be dynamically assigned when logging on. Within private networks, the IP address can even be apportioned. A connection of all computers with correspondingly assigned IP addresses in a private network to computers on the Internet is carried out by means of a Network Address Translation NAT.

With protocols such as BOTP or DHCP, IP addresses can be assigned by a corresponding network server when network elements log on to a network. A range of IP addresses from which other network elements can have a corresponding IP address assigned to them can be defined on the network server. However, an address of this kind is not a fixed address, but rather is valid only for the time that the network element is logged on to the network. In case the network element requires a fixed IP address, the network elements can determine a MAC address (Media Access Control), e.g., via the ARP protocol, and can then obtain a permanent IP address.

A client, mentioned above, is an application which uses a service of a server in a network. Accordingly, a client can be a computer or a network element in a corresponding network.

As was described above, a mobile device preferably has a unique identification, for example, an IP address. A mobile device can establish communication with a private or public server by means of this identification, for example, based on an Internet Protocol. Based on the unique IP address, a server can accurately identify this device and can therefore determine whether or not this device has the appropriate authorization to access the server. Based on the unique identification by the IP address, the server can determine which format, particularly which audio format, can be processed by the mobile device. If necessary, the requested files can be converted into a format which can be processed by the mobile device insofar as the requested file is not present on the server in this format.

Alternatively or in addition, it is possible to provide a server that controls a communication between the mobile end device and another server, the files requested by the mobile device being stored on this second server, i.e., the target server. As was described above, the mobile device can be uniquely identified, for example, by an IP address. The second target server preferably also has an IP address so that this server can also be uniquely determined. Therefore, the third-party server or mediation server can ensure that the mobile device and the target server both have the appropriate authorization. When this has been clarified, the file found on the target server can be transferred to the mobile device by the mediation server, as the case may be.

Alternatively, a direct communication can be established between the target server and the mobile device so that the mediation server merely serves to check on appropriate authorization and to establish direct communication. Conversion of the requested file into a format that can be processed by the mobile device can be carried out either on the target server or on the mediation server. In this way it is ensured that the file requested by the mobile device is always transferred to the mobile device in the desired format.

The mediation server can have a database in which are stored the data of all common mobile devices and the formats which can be read and processed by the mobile device. Alternatively or in addition, the mobile device can also transmit information about the formats that can be processed by the mobile device along with its request for the file to be transferred. In this way, it can be ensured that the mobile device always receives the desired files in a format that can be read by the mobile device, i.e., therefore, a manufacturer-independent data transfer is possible.

Although the present invention mainly shows an IP address for the identification of a mobile device, a mobile device can also be identified, for example, by a MAC address of the device or by a manufacturer's number. Accordingly, the mobile device could, for example, transmit its model number and the corresponding manufacturer's number when transmitting its request for a file.

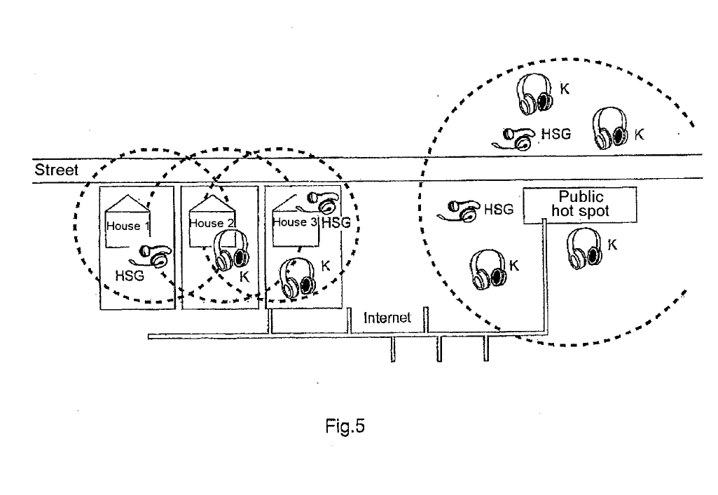

FIG. 5 shows a multimedia network according to a first embodiment example of the invention. The multimedia network shown in FIG. 5 can be implemented, for example, in the multimedia network according to FIG. 4. In so doing, network elements with a corresponding WLAN interface can communicate with the network within a transmission range of the access points (R_A1, WLAN_A2, WLAN_A3 in FIG. 4). For this purpose, an IP address is dynamically assigned to the corresponding network elements, for example, by the central router R_A1 or by a central service. Alternatively, every network element can have a permanent IP address. The dotted circles show the respective transmission ranges of the different access points. For example, FIG. 5 shows on the left-hand side three houses, house 1 to house 3, each of which has an access point. This access point is connected, for example, to a so-called public hot spot, i.e., a public access point, via the Internet. The headphones K and the headset HSG according to FIG. 5 have a WLAN interface and an IP address has been assigned to them. In particular, the headphones K have a WLAN interface integrated in their housing. The same is true for the headset HSG. Accordingly, audio data can be transmitted wirelessly in the WLAN network directly to the network element designed as headphones. Therefore, all of the functions in the reception zone and the private and public WLAN networks can be used wirelessly by the headphones or the headset without additional accessories. In this way, for example, audio files from a private network-capable PC or from a music server can be transmitted to and played back on the wireless headphones wirelessly. Alternatively, the headphones and the headset can be used for live listening to Internet radio. The headsets HSG can also be used for Internet telephony, i.e., for Voice over IP.

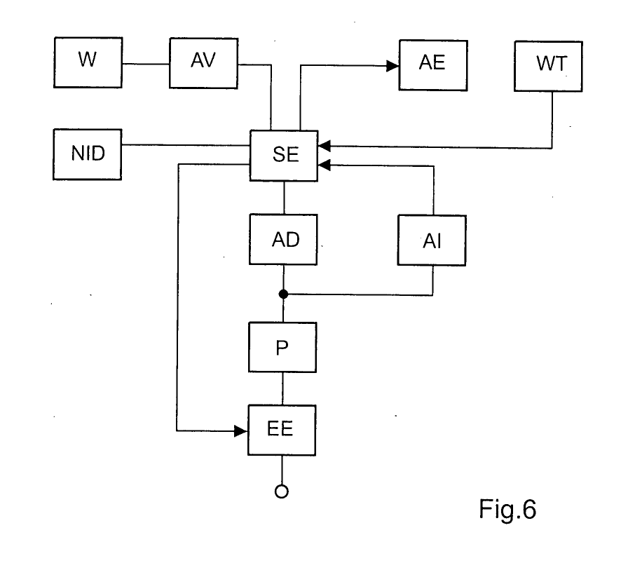

FIG. 6 shows a schematic block diagram of a mobile device. The mobile device has a transmission/reception unit EE for wireless transmission and reception, a buffer P for temporary storage of the received signals, an audio decryption unit AD, a central control unit SE, a network identification unit NID, an audio amplifier AV, and at least one electroacoustic transducer W. In addition, the mobile device can have an auxiliary information unit AI, a display unit AE and selector buttons WT. The transmission and reception unit EE is, for example, a WLAN interface according to IEEE 802.11 X. The mobile device can accordingly communicate wirelessly with a network by means of this WLAN interface. A buffer P for temporary storage of the signals received by the transmission/reception unit EE is connected to the transmission/reception unit EE. The audio decryption unit AD decrypts the signals stored in the buffer P and directs the decrypted signals to the central control unit SE. The auxiliary information unit AI serves to decrypt the received signals and temporarily stored signals for possible help information or with respect to additional information. The decrypted additional information is likewise sent to the control unit SE.

When the mobile device is switched on and logs on to the wireless network, it is assigned an IP address by a network server. The IP address received by the transmission/reception unit EE is sent to the control unit SE by the auxiliary information unit AI and, finally, is stored in the network identification unit NID. The audio amplifier unit AV and the electroacoustic transducer are also connected to the central control unit. The signals received by the transmission/reception unit EE are decrypted by the audio decryption unit AD and outputted to the audio amplifier unit AV and transducer W by the control unit.

The control unit SE is also connected to a display unit AE and sends help information and additional information about the transferred audio data to the display unit AE so that they can be displayed on the latter. This can be, for example, the title and performer of a piece of music that is currently being played.

Further, selector buttons WT are provided preferably externally at the housing of the mobile device. These selector buttons can be, for example, a volume control. Alternatively or in addition, buttons can also be provided by which the user of a mobile device can, for example, access a network server in the WLAN network and request data. Accordingly, for example, music titles stored on a server can be selected so as to load them into the wireless headphones and play them back. The selector buttons WT can also be used to make a playlist, for example. Alternatively, the playlist can also be made up on the network server or on another network element such as, e.g., a network-capable computer, and transferred to the headphones.

Since the mobile device according to FIG. 6 has a unique IP address, a direct communication can be established with it in a WLAN network. Further, any computer with its own IP address can speak to the mobile device provided they are both connected to the Internet.

In addition, the transmission/reception unit can also have a Bluetooth interface so that the data received by the WLAN interface can be transferred to other devices. Therefore, for example, WLAN headphones can forward the audio signals to be played back via its Bluetooth interface to another Bluetooth headset or headphones so that, for example, two persons can listen to the same piece of music.

While the foregoing description and drawings represent the present invention, it will be obvious to those skilled in the art that various changes may be made therein without departing from the true spirit and scope of the present invention.

What is claimed is:

1-4. (canceled)

5. A method for transferring data, in particular data pertaining to copyright, from a server with a first Internet Protocol address to a mobile device with a second Internet Protocol address, comprising the following steps:
transmitting a request for at least one file by a mobile device;
receiving the request of the mobile device through a first server;
identifying the mobile device based on its Internet Protocol address;
checking the authorization of the mobile device; and
transferring the requested file from the server to the mobile device when the mobile device has an appropriate authorization.

6. A method according to claim 5, wherein information about the formats that can be played back by the mobile device are transmitted along with the request for the file to be transferred, wherein the server converts the requested file into a format which can be processed by the mobile device provided the requested file is not already in an appropriate format on the server.

7. A method according to claim 5, wherein the requested data is an audio file.

8. A method according to claim 5, wherein the formats that the mobile device can process are determined based on the IP address of the mobile device, and wherein the server converts the requested file into a format which can be processed by the mobile device provided the requested file is not already in an appropriate format on the server.
